(19) United States
(12) Patent Application Publication
(10) Pub. No.: US 2017/0283003 A1
(43) Pub. Date: Oct. 5, 2017

(54) SUPPORT FOR SMOOTH PEDALLING ON A BICYCLE

(71) Applicant: Continental Teves AG & Co. oHG, Frankfurt, OT (DE)

(72) Inventor: Ulrich Stählin, Eschborn (DE)

(73) Assignee: Continental Teves AG & Co. oHG, Frankfurt, OT (DE)

(21) Appl. No.: 15/510,698

(22) PCT Filed: Sep. 15, 2015
(86) PCT No.: PCT/EP2015/071112

§ 371 Date: Mar. 13, 2017

(30) Foreign Application Priority Data
Sep. 17, 2014 (DE) 10 2014 218 683.8

(51) Int. Cl. B62M 6/50; B62M 6/55

(52) U.S. Cl. CPC B62M 6/50; B62M 6/55; B62M 6/45

(57) ABSTRACT

The invention relates to a method for supporting a driver of a bicycle (2) for the pedal drive via a pedal bearing shaft (16) of a pedal bearing (12) arranged on the bicycle, comprising:—detecting a pedalling torque (34) applied by the driver of the bicycle (2) onto the pedal bearing shaft (16) via a rotational angle (68) of the pedal bearing shaft (16), and—outputting an auxiliary signal (79) when a comparison (74) of the pedalling torque (36) and the rotational angle (68) deviates from a predetermined condition (73).

The invention relates to a method for assisting a rider of a bicycle during the pedal-driving via a bottom bracket shaft of a bottom bracket which is present on the bicycle, a control device for carrying out the method, and a bicycle having the control device.

DE 10 2011 109 441 A1 discloses a bicycle with an auxiliary motor which is referred to as a Pedelec and is configured to assist the rider of the bicycle with auxiliary energy for the drive.

The object of the invention is to improve the detection of the torque on the bottom bracket shaft in a bicycle.

The object is achieved by means of the features of the independent claims. Preferred developments are the subject matter of the dependent claims.

According to an aspect of the invention, a method for assisting a rider of a bicycle during pedal-driving via a bottom bracket which is present on the bicycle includes the steps of detecting a pedaling torque which is applied to the bottom bracket shaft by the rider of the bicycle over a rotational angle of the bottom bracket shaft and outputting an auxiliary signal if a comparison of the pedaling torque and of the rotational angle differs from a predetermined condition.

The specified method is based on the idea that the rider generally uses a pedal to apply to the bottom bracket shaft of the bicycle a pedaling torque which is dependent on the rotational angle position of the bottom bracket shaft. For example, the pedaling torque which is applied to the bottom bracket shaft by the rider differs at the dead centers from the torque at half the height between the dead centers. When riding uphill, for example, this can lead to a situation in which at a quite specific angular position the rider suddenly can no longer make available sufficient pedaling torque to the drive of the bicycle, and is therefore forced to get off.

Here, the specified method comes in with the proposal to compare the rotational angle position of the bottom bracket shaft and the pedaling torque applied by the rider while he is riding the bicycle. The information which can be derived from the comparison can then be used further in various ways in order to provide the rider with various assistance functions during the riding. These assistance functions can be used by the rider in various ways in order, for example, to save energy when pedaling, to optimize his pedaling method, etc.

In order to generate the abovementioned information, the comparison of the pedaling torque and of the rotational angle is compared with a predetermined condition, wherein the auxiliary signal is output if the predetermined condition is not satisfied. With the predetermined condition it is therefore possible to define an optimum pedaling behavior of the rider as a function of the rotational angle of the bottom bracket shaft. If the real pedaling behavior differs from this optimum pedaling behavior, the rider can be assisted actively or passively by means of the auxiliary signal.

In one development of the specified method, a fluctuation in the pedaling torque over the rotational angle is smaller than a predetermined value within the scope of the predetermined condition. In a particularly preferred way, the predetermined condition is defined in such a way that the pedaling torque is essentially constant over the rotational angle. Under this predetermined condition, the optimum pedaling behavior of the rider is what is referred to as circular pedaling. However, in order to permit tolerance for the pedaling behavior of the rider here, relatively small fluctuations in the pedaling torque over the pedaling angle should not be included in the previously mentioned comparison.

In order to actively assist the rider, an auxiliary torque can be superimposed on the pedaling torque, on the basis of the auxiliary signal in an additional development of the specified method. In this way, the function of the Pedelec referred to at the beginning or the bicycle which is referred to as an e-bike is expanded with an auxiliary motor. In a conventional Pedelec, the torque with which the rider acts on the pedal crank is ascertained, and the assistance torque provided by the e-motor is determined therefrom, by a torque sensor. Within the scope of the specified method, the rotational angle of the bottom bracket shaft is additionally measured, in order to assist the rider of the bicycle by means of the auxiliary motor as the rider pedals in a circular fashion. In this context, the auxiliary signal can be used to detect which phase or the pedaling cycle (push phase, pull phase, lift phase, thrust phase) the rider of the bicycle is currently in. On the basis of this information in the auxiliary signal it is derived or predicted how much pedaling torque the rider will apply compared to the previous phases, and therefore how much additional auxiliary torque, also referred to as assistance torque, is necessary to keep the total torque constant within the scope of the circular pedaling. This is because the objective within the scope of the specified development of the method should be to keep the total of the pedaling torque and auxiliary torque constant over one complete pedaling cycle.

Therefore, in one particular development of the specified method, the auxiliary torque should be generated in such a way that a comparison of a total torque, composed of the pedaling torque and the auxiliary torque, and of the rotational angle, satisfies the predetermined condition. In the simplest case, the total torque could for this purpose be compensated on the basis of the auxiliary torque. All the classic control methods are possible for this, that is to say PID controllers, state controllers and the like.

In one preferred development, the specified method comprises the step of pilot-controlling the generated auxiliary torque on the basis of an estimate of the profile of the pedaling torque plotted against the rotational angle. The pilot control can be configured here as application of a guide variable or as application of an interference variable and brings about an improved control behavior of the closed-control circuit which is produced because the differences which are to be compensated in this way between the pedaling torque of the rider and the total torque are in this way kept as small as possible and therefore fluctuations in the closed-control circuit are as far as possible avoided. The estimate of the pedaling torque profile of the rider plotted against the rotational angle can be carried out here in any desired way. The following procedures are appropriate:
A very simple model can be used as the basis, within the scope of which a maximum pedaling torque is assumed during the push phase of each leg of the rider and otherwise no pedaling torque is assumed. In this case the pedaling torque should be measured, for example, during the push phase, wherein it would not be necessary here to differentiate between the push phase and other phases because it can be assumed that the pedaling torque is at a maximum in the push phase. The push phase should preferably be detected by means of the rotational angle of the bottom bracket shaft, wherein a fixed value, e.g. between 45° and 135°, could be assumed for the rotational angle of the bottom bracket shaft in the push phase.
Alternatively or additionally, a learning algorithm, such as, for example, a neuron network, a Bayes network, polynomial, etc. could be used, within the scope of which the relative profile of the pedaling torque plotted against the rotational angle is learnt over a plurality of pedaling cycles. Learning is to be understood here as meaning an iterative process in the scope of which a stored profile of the pedaling torque plotted against the rotational angle is continuously corrected on the basis of current measurements.
Various profiles of the pedaling torque plotted against the rotational angle could also alternatively or additionally be entered with various reference riders and stored. Subsequently, during the riding it could be determined which of the profiles has the smallest deviation from the profile of the pedaling torque plotted against the rotational angle of the current rider. This profile can then be used. Alternatively, the rider himself could select a profile of the pedaling torque plotted against the rotational angle which is suitable for him as a basis for the abovementioned closed-loop control, also according to specific criteria such as sporty, comfortable, off-road, etc.

In another development, the specified measure comprises the step of avoiding superimposing the auxiliary torque if the comparison of the pedaling torque and of the rotational angle satisfies a further predetermined condition. This further predetermined condition could be defined in such a way that the approaching of the rider's pedaling behavior to the abovementioned optimum pedaling behavior can also be stopped under certain conditions, in particular in certain traffic situations.

In this context, the further predetermined condition can be dependent on an acceleration request and/or a braking request of the rider. If, for example, it is detected that in one phase of the pedaling cycle the rider pedals significantly more strongly or more weakly than hitherto, it is possible to deviate from optimization to the most constant possible pedaling torque so that the rider can also accelerate and brake. Ideally, for this purpose a further threshold value in the fluctuation of the pedaling torque, starting from which the assistance with the auxiliary torque is to be ended, can be defined as a further predetermined condition. One possibility is additionally to allow this threshold value to be set by the rider, possibly within predetermined limits.

In yet another development, the specified method comprises the step of outputting a message to the rider on the basis of the auxiliary signal, because instead of the abovementioned assistance to achieve circular pedaling or in addition to this assistance, the rider's deviation from circular pedaling can also be displayed to said rider. This may be done either continuously by means of instantaneous values or using statistical values ((sliding) mean value, median, maximum, minimum, . . . ). Possible variables are the relative and the absolute deviation or the angle with the greatest deviation. Therefore, instead of a more suitable assistance during riding a characteristic variable for training is made available.

According to a further aspect of the invention, a control device is configured to carry out one of the specified methods.

In one development of the specified control device, the specified device has a memory and a processor. In this context, the specified method is stored in the form of a computer program in the memory, and the processor is provided for running the method when the computer program is loaded from the memory into the processor.

According to a further aspect of the invention, a computer program comprises program code means for carrying out all the steps of one of the specified methods when the computer program is run on a computer or one of the specified devices.

According to a further aspect of the invention, a computer program product contains a program code which is stored on a computer-readable data carrier and which carries out one of the specified methods when it is run on a data processing device.

According to a further aspect of the invention, a bicycle comprises a frame which is movably held on an underlying surface via at least one wheel, a bottom bracket having a bottom bracket shaft for driving the wheel on the basis of a pedaling torque applied by the rider, and one of the specified control devices.

The properties, features and advantages of this invention which are described above as well as the way in which they are achieved become more clearly understandable in conjunction with the following description of the exemplary embodiments which are explained in more detail in conjunction with the drawings, in which:

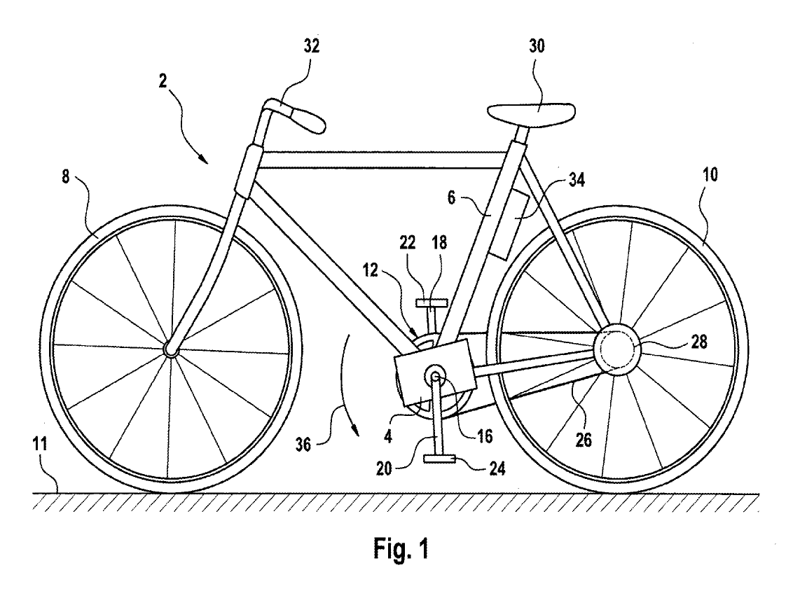

FIG. 1 shows a schematic illustration of a bicycle having an assistance-providing auxiliary drive,

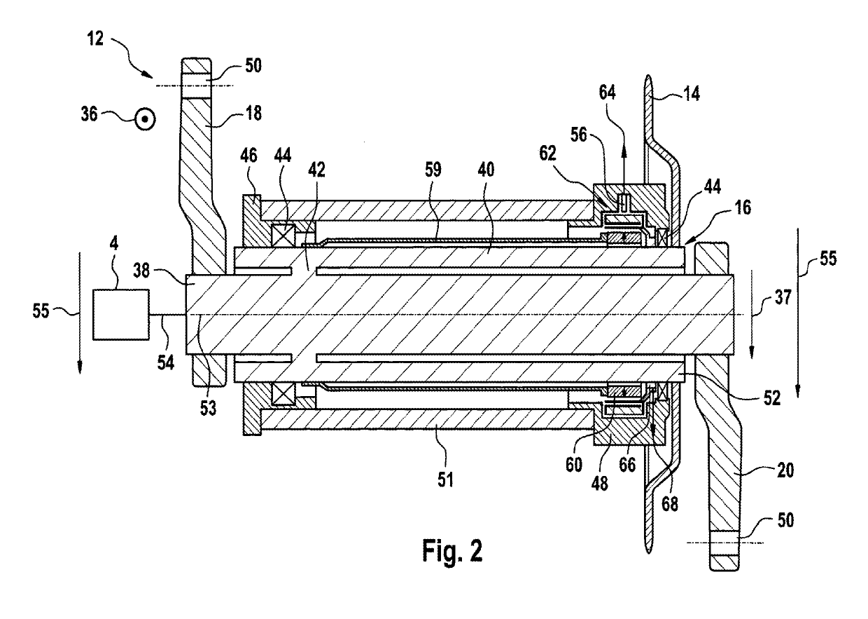

FIG. 2 shows a schematic illustration of a bottom bracket for the bicycle in FIG. 1, and

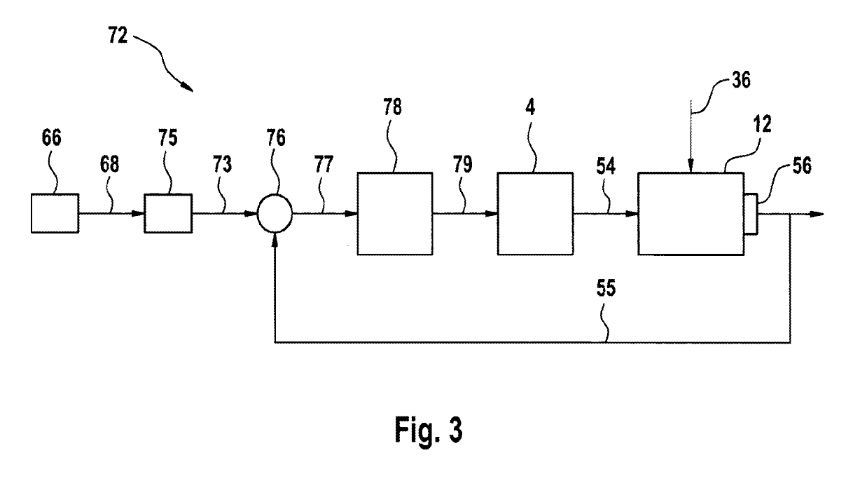

FIG. 3 shows a schematic illustration of a closed-loop control circuit in the bicycle in FIG. 1.

In the figures, identical technical elements are provided with the same reference symbols and described only once.

Reference is made to FIG. 1 which shows a schematic illustration of a bicycle 2 with an assistance-providing auxiliary drive 4.

The bicycle 2 has a frame 6 which is supported in a ridable fashion on an underlying surface 11, such as, for example, a road, via a front wheel 8 and a rear wheel 10. In this context, the rear wheel 10 can be driven via a bottom bracket 12, which will be described below.

The bottom bracket 12 has a chain ring 14 which is shown in FIG. 2 and which is connected, in a way to be described below, in a rotationally fixed fashion to a bottom bracket shaft 16, also referred to as a crankshaft. In a manner known per se, two crank arms 18, 20 project from the bottom bracket shaft 16, a pedal 22, 24 being rotatably held at the ends of each crankshaft 18, 20 lying opposite the bottom bracket shaft 16. A rider of the bicycle 2 can then rotate the bottom bracket shaft 16, and therefore the chain ring 14, by stepping on one of the pedals 22, 24. In the process, the rotating chain ring 14 moves a chain 26 which in turn transmits the rotation of the chain ring 14 to a gearwheel 28 which is secured in a rotationally fixed fashion to the rear wheel 10. In this way, the rear wheel 10 is driven, as a result of which the bicycle 2 can be moved on the underlying surface 11 by the pedaling movements of the rider. Instead of the gearwheel 28 which is secured in a rotationally fixed fashion to the rear wheel 10, a gearwheel which is secured to what is referred to as a gear shift can also be used, wherein the gear shift can be embodied in what is referred to as a hub gear shift, wherein the transmission is then located within the wheel hub of the rear wheel, or can be embodied as what is referred to as a derailleur system, in which the transmission is located in an openly accessible fashion on the wheel hub.

The rider himself can sit on a saddle 30 during his pedaling movements and can hold onto a handlebar 32 for controlling the bicycle 2.

Within the scope of the present embodiment, the auxiliary drive 4 is provided for assisting the rider during the driving of the bicycle 2. Said auxiliary drive 4 is supplied with the necessary auxiliary energy from an electrical energy source 34 and is to be connected as a function of the rider's request by the rider. Such an auxiliary drive 4 is known, for example, from DE 10 2011 087 544 A1, wherein bicycles with such auxiliary drives are also referred to as Pedelecs. Further information on Pedelecs can be found in the document specified above.

Within the scope of the present embodiment, the auxiliary drive 4 is provided as a means for assisting the rider of the bicycle 2 and is to assist the pedaling torque 36 of the rider with an auxiliary torque 54 which is indicated in FIG. 2 in such a way that a pedaling cycle acting on the bottom bracket shaft 16 follows circular pedaling. For this purpose it is necessary for the total torque 37 which acts on the bottom bracket shaft 16 and is indicated in FIG. 2 to be detected and it should be kept constant in order to implement a pedaling cycle according to circular pedaling by means of the auxiliary motor 4.

Before more details are given on the generation of the pedaling cycle according to circular pedaling, firstly an explanation will be given on the basis of FIG. 2 of the detection of the total torque acting on the bottom bracket shaft 16. A precondition for the present embodiment is that:

within the scope of the present embodiment the bottom bracket shaft 16 is constructed in two parts from an internal shaft element 38 and a twistable hollow shaft element 40, wherein the internal shaft element 38 is held concentrically in the hollow shaft element 40. In this context, the internal shaft element 38 and the hollow shaft element 40 are connected to one another in a rotationally fixed fashion at a first shaft section 42.

The bottom bracket shaft 16 is rotatably held on the hollow shaft element 40 by means of rolling elements 44 in a first bearing shell 46 and in a second bearing shell 48 so as to be rotatable about a rotational axis 53. In this context, a bottom bracket housing 51 for protecting the bottom bracket shaft 16 is fitted radially onto the bearing shells 46, 48. In this context, the two crank arms 18, 20 are each arranged spaced apart axially from the bearing shells 46, 48, wherein securing bores 50 lead through the crank arms 18, 20 in order to secure the pedals 22, 24.

The chain ring 14 is held by means of a second shaft section 52.

If the rider then steps on the pedals 22, 24, the hollow shaft element 40 is twisted between the first shaft section 42 and the second shaft section 52 owing to the applied pedaling torque 36 and the inertia of the bicycle 2. The larger the applied pedaling torque 36, the more force is applied by the rider to the bicycle 2, in order to increase the speed of the bicycle 2 without, however, the desired success being achieved—as, for example, on a very steep hill on which the necessary application of force by the rider himself is very high on low gradients.

The auxiliary drive 4 could intervene here and drive the bicycle 2 with an auxiliary torque 54. In this way, the auxiliary torque 54 is superimposed on the pedaling torque 36 applied by the rider to form a total torque 55, as a result of which the pedaling torque 36 which has to be applied by the rider is reduced. In FIG. 2, the auxiliary drive 4 engages on the bottom bracket shaft 16, illustrated schematically for the sake of clarity. The auxiliary drive 4 could, however, engage at any other desired location on the drive of the bicycle 2.

In order to determine the auxiliary torque 54 which is to be applied, the total torque 55 which is applied to the bottom bracket shaft 16 could be detected, said total torque 55 being measured within the scope of the present embodiment on the basis of a differential angle between the first shaft section 42 and the second shaft section 52. If this differential angle is known, the applied pedaling torque 36 can be derived via the material characteristic variables of the hollow shaft element 40.

The differential angle is detected within the scope of the present embodiment with a measuring pickup which is embodied as a magnetic-field-sensitive sensor element 56, such as, for example, a Hall sensor element or a magneto-resistive sensor element. The magnetic-field-sensitive sensor element 56 detects an encoder field which extends in the circumferential direction of the bottom bracket shaft 16 and is in the form of an encoder magnetic field which is excited by an encoder which is secured in a positionally fixed fashion to the first shaft section 42 via a sleeve 59 and is in the form of an encoder magnet 60 which is constructed as an encoder ring.

The encoder magnetic field is picked up by a conduction element 62 which is arranged in a positionally fixed fashion with respect to the second shaft section 52 and is conducted through the magnetic-field-sensitive sensor element 56 and fed back to the encoder magnet 60. The magnitude of the encoder magnetic field conducted from the conductor element 62 to the magnetic-field-sensitive sensor element 56 depends here, in a way described in WO 02/071019 A1, on the differential angle between the first shaft section 42 and the second shaft section 52. Therefore, the differential angle can be derived directly from the encoder magnetic field 58 sensed by the magnetic-field-sensitive sensor element 56 and output via a signal cable as a differential angle signal 64 which is dependent on the total torque 55 to be sensed.

In addition to the differential angle signal 64 and therefore the total torque 55, within the scope of the present embodiment it is additionally also possible to sense the rotational angle position of the bottom bracket shaft 16 on the basis of the encoder magnetic field of the encoder magnet 60. For this purpose, within the scope of the present embodiment a further magnetic-field-sensitive sensor element 66 is arranged which can output a rotational angle position signal 68 which is dependent on the rotational angle position of the bottom bracket shaft 16. This angle position signal 68 can be generated, for example, in the same way as in DE 10 2012 204 141 A1.

Reference is made to FIG. 3 which shows a closed-loop control circuit 72 with the bottom bracket 12 as a controlled system.

The objective of the closed-loop control circuit 72 is to superimpose the auxiliary torque 54 on the pedaling torque 36 applied to the bottom bracket 12 by the rider of the bicycle 2 in such a way that the total torque 55 satisfies a predetermined condition 73 by means of the rotational angle of the bottom bracket shaft 16 and therefore by means of the profile of the angle position signal 68. This predetermined condition 73 is selected within the scope of the present embodiment in such a way that the total torque 55 remains constant when viewed in a steady-state load state by means of the rotational angle of the bottom bracket shaft 16. A steady-state load state is to be understood here within the scope of the present exemplary embodiment as a state in which the rider rides with the bicycle 2 at a constant speed on an underlying surface with a constant gradient profile, with the result that in this state without the auxiliary torque 54 the rider would always have to apply constant pedaling torque 36 in order to maintain the speed of the bicycle 2.

In order to keep the total torque 55 constant according to the predetermined condition in the steady-state load state of the bicycle 2, the total torque 55 is compared in a subtractor 76 with the predetermined condition which can be a setpoint torque within the scope of the present embodiment. This setpoint torque 73 directly follows from the angle position signal 68 and can be determined, for example, from the angle position signal 68 within the scope of a characteristic curve 75. If the total torque 55 deviates from the setpoint torque 73, with the result that a closed-loop control difference 77 which is unequal to zero is produced, it is then possible to use a closed-loop controller 78 which is known per se and is of any desired design to generate a suitable actuation signal 79 for the auxiliary drive 4 which then in turn generates the auxiliary torque in order to adjust the closed-loop control difference 77 back to zero and to satisfy the predetermined condition 73 and therefore the setpoint torque 73.

1.-10. (canceled)

11. A method for assisting a rider of a bicycle during pedal-driving via a bottom bracket shaft of a bottom bracket comprised on the bicycle, the method comprising:
detecting a pedaling torque which is applied to the bottom bracket shaft by the rider of the bicycle over a rotational angle of the bottom bracket shaft; and
outputting an auxiliary signal if a comparison of the pedaling torque and of the rotational angle differs from a predetermined condition.

12. The method as claimed in claim 11, wherein a fluctuation in the pedaling torque over the rotational angle is smaller than a predetermined value within the scope of the predetermined condition.

13. The method as claimed in claim 11 further comprising superimposing an auxiliary torque on the pedaling torque, on the basis of the auxiliary signal.

14. The method as claimed in claim 13 further comprising generating the auxiliary torque in such a way that a comparison of a total torque, composed of the pedaling torque, the auxiliary torque, and the rotational angle, satisfies the predetermined condition.

15. The method as claimed in claim 14 further comprising pilot-controlling the generated auxiliary torque on the basis of an estimate of the profile of the pedaling torque plotted against the rotational angle.

16. The method as claimed in claim 13 further comprising avoiding superimposing the auxiliary torque if the comparison of the pedaling torque and of the rotational angle satisfies a further predetermined condition.

17. The method as claimed in claim 16, wherein the further predetermined condition is dependent on an acceleration request and/or a braking request of the rider.

18. The method as claimed in claim 11 further comprising outputting a message to the rider on the basis of the auxiliary signal.

19. The method as claimed in claim 11, wherein a pedaling cycle acting on the bottom bracket shaft follows circular pedaling, and wherein a total torque which acts on the bottom bracket shaft is kept constant by an auxiliary motor.

20. A control device configured to assist a rider of a bicycle during pedal-driving via a bottom bracket shaft of a bottom bracket comprised on the bicycle, the control device comprising a component for detecting a pedaling torque which is applied to the bottom bracket shaft by the rider of the bicycle over a rotational angle of the bottom bracket shaft, and system for outputting an auxiliary signal if a comparison of the pedaling torque and of the rotational angle differs from a predetermined condition.

21. The control device as claimed in claim 20, wherein a fluctuation in the pedaling torque over the rotational angle is smaller than a predetermined value within the scope of the predetermined condition.

22. The control device as claimed in claim 20 further comprising superimposing an auxiliary torque on the pedaling torque, on the basis of the auxiliary signal.

23. The control device as claimed in claim 22 further comprising generating the auxiliary torque in such a way that a comparison of a total torque, composed of the pedaling torque, the auxiliary torque, and the rotational angle, satisfies the predetermined condition.

24. The control device as claimed in claim 23 further comprising pilot-controlling the generated auxiliary torque on the basis of an estimate of the profile of the pedaling torque plotted against the rotational angle.

25. The control device as claimed in claim 24 further comprising avoiding superimposing the auxiliary torque if the comparison of the pedaling torque and of the rotational angle satisfies a further predetermined condition.

26. The control device as claimed in claim 25, wherein the further predetermined condition is dependent on an acceleration request and/or a braking request of the rider.

27. The control device as claimed in claim 20 further comprising outputting a message to the rider on the basis of the auxiliary signal.

28. The control device as claimed in claim 20, wherein a pedaling cycle acting on the bottom bracket shaft follows circular pedaling, and wherein a total torque which acts on the bottom bracket shaft is kept constant by an auxiliary motor.

29. A bicycle comprising:
a frame which is movably held on an underlying surface via at least one wheel;
a bottom bracket comprising a bottom bracket shaft for driving the wheel on the basis of a pedaling torque applied by the rider; and,
a configured to assist a rider of a bicycle during pedal-driving via a bottom bracket shaft of a bottom bracket comprised on the bicycle, the control device comprising a component for detecting a pedaling torque which is applied to the bottom bracket shaft by the rider of the bicycle over a rotational angle of the bottom bracket shaft, and system for outputting an auxiliary signal if a comparison of the pedaling torque and of the rotational angle differs from a predetermined condition;
wherein a pedaling cycle acting on the bottom bracket shaft follows circular pedaling, and wherein a total torque which acts on the bottom bracket shaft is kept constant by an auxiliary motor.

30. The bicycle as claimed in claim 29, wherein a message is outputted to a rider on the basis of the auxiliary signal.
